(19) United States
(12) Patent Application Publication
(10) Pub. No.: US 2025/0269893 A1
(43) Pub. Date: Aug. 28, 2025

(54) COMPACT COLLAPSIBLE STROLLER

(71) Applicant: WONDERLAND SWITZERLAND AG, STEINHAUSEN (CH)

(72) Inventors: Andrew J. HORST, Morgantown, PA (US); Daniel A. SACK, Mohnton, PA (US)

(21) Appl. No.: 19/038,869

(22) Filed: Jan. 28, 2025

Related U.S. Application Data
(63) Continuation of application No. 17/756,454, filed on May 25, 2022, now Pat. No. 12,246,768.
(60) Provisional application No. 62/941,303, filed on Nov. 27, 2019.

(51) Int. Cl. B62B 7/08; B62B 7/06; B62B 7/14

(52) U.S. Cl. CPC B62B 7/083; B62B 7/064; B62B 7/14; B62B 7/142; B62B 7/147

(57) ABSTRACT

Disclosed is a compact foldable stroller, which comprises a main stroller frame. The main stroller frame comprises a central frame hub, and a handle part, a rear leg part and a front leg part that can separately be pivotally coupled to the central frame hub. The main stroller frame further comprises a fitting part attached to the handle part. The compact foldable stroller has an unfolded state for use and a folded state for storage. When the compact foldable stroller changes from the unfolded state to the folded state, the fitting part approaches a rear wheel set. The main stroller frame can be compactly folded by means of a series of pivot points, which may accept child seats of various configurations during installation. The seat can be folded in a manner suitable to the folding boundary size of the main stroller frame, thereby keeping the folding size of the stroller unit minimal.

### PRIORITY CLAIM

The present application is a Continuation of U.S. patent application Ser. No. 17/756,454 filed May 25, 2022; which is a National Phase application of PCT Application Serial No. PCT/IB2020/061216 filed Nov. 27, 2020; which claims priority to U.S. Provisional Application Ser. No. 62/941,303 filed Nov. 27, 2019. The disclosure of the above patent(s)/application(s) is incorporated herein by reference.

### FIELD OF THE INVENTION

The present disclosure generally relates to a stroller used to transport children while the caregiver is walking outside of the home. More particularly, the invention relates to a stroller capable of folding to a compact size while still allowing for multiple seating modes for the child.

### BACKGROUND OF THE INVENTION

There are several strollers in the market that allow the child seat to be attached to the main stroller frame in multiple configurations, as well as strollers that are able to fold to a compact and easily transported size. Currently strollers that offer multiple seating modes for the child do not fold to a compact size that is easy to transport. Furthermore, stroller that are able to fold to a compact size, often do not have full features on the child seat or the main stroller frame, in addition to small wheels that do not allow the stroller to handle uneven terrain.

### SUMMARY OF THE INVENTION

The present disclosure relates to a compact collapsible stroller which can reduce or eliminate at least one of the above-mentioned disadvantages.

This disclosure features a main stroller frame and a child seat that can be attached to the main stroller frame in multiple configurations.

It is a feature of this disclosure that the stroller is folded in two steps because the child seat folds separately from the main stroller frame.

It is a feature of this disclosure that as part of the seat fold, the seat frame is released to pivot around the seat mount so that both the upper and lower seat frames hang relatively vertical with respect to the seat mount.

The present disclosure provides a compact collapsible stroller including a main stroller frame. The main stroller frame includes a central frame hub and a handle portion, a rear leg portion, and a front leg portion pivotally coupled to the central frame hub. The main stroller frame further includes an adapter portion attached to the handle portion. The compact collapsible stroller has an unfolded state for use and a folded state for storage, and the adapter portion approaches rear wheels when the compact collapsible stroller is transformed from the unfolded state to the folded state.

In one embodiment, in the folded state, the central frame hub and a seat mount overlap in a lateral direction

In one embodiment, in the folded state, each of the handle portion, the rear leg portion, and the front leg portion substantially vertically extends downward from the central frame hub, and each of an upper frame, a lower frame and a child tray substantially vertically extends downward from the seat mount.

In one embodiment, the handle portion comprises: a lower handle portion pivotally coupled to the central frame hub; a handle portion hub is formed at an end of the lower handle portion opposite to the central frame hub; an upper handle portion pivotally coupled to the handle portion hub.

In one embodiment, the rotation of the upper handle portion can disengage the lower handle portion from the central frame hub, so that the lower handle portion can rotate relative to the central frame hub.

In one embodiment, the rotation of the lower handle portion relative to the central frame hub causes the seat mount to approach to the central frame hub.

In one embodiment, the main stroller frame further comprises a carrying basket extending backward from the rear leg portion, and when the compact collapsible stroller changes from the unfolded state to the folded state, the carrying basket rotates and compactly closes to the rear leg portion.

In one embodiment, the main stroller frame further includes: an upper link attached to the adapter portion and pivotally connected to the handle portion; a lower link pivotally connected to the rear leg portion and the upper link.

In one embodiment, the compact collapsible stroller further includes a basket frame which attached between the lower link and a pivot point on the rear leg portion.

In one embodiment, when transforming from the unfolded state to the folded state, through the downward pivoting movement of the handle portion, the upper link drives the lower link in a downward movement, thereby driving the basket frame attached to the lower link to rotate corresponding to the pivot point on the rear leg portion.

In one embodiment, the compact collapsible stroller has a rectangular folding boundary, and when the compact collapsible stroller is transformed from the unfolded state to the folded state, none of parts of the compact collapsible stroller exceed beyond the folding boundary.

It is an advantage of this disclosure that the child seat frame pivot is located to allow the seat frame to be folded within the main stroller frame folding boundary.

It is an advantage of this disclosure that the child tray is released from a locked position and able to pivot relative to the child seat frame during the motion of folding the child seat frame.

It is an advantage of this disclosure that the free pivoting vertical orientation allows the seat to find an optimal storage location within the main stroller frame folding boundary.

### BRIEF DESCRIPTION OF THE DRAWINGS

Various objects, features and advantages of the present disclosure will become more apparent from the detailed descriptions of exemplary embodiments of the present disclosure with reference with the accompanying drawings. The drawings are merely schematic illustrations of the present disclosure and are not necessarily drawn to scale. In the drawings, the same reference numerals refer to the same or similar components throughout the present disclosure.

FIG. 1 is a perspective view of the compact collapsible stroller of the present disclosure;

FIG. 2 is a perspective view of the child seat frame of the compact collapsible stroller of the present disclosure;

FIG. 3 is a perspective exploded view of the child seat frame of the compact collapsible stroller of the present disclosure;

FIG. 3A is a perspective exploded view of some parts of the child seat frame of the compact collapsible stroller of the present disclosure;

FIG. 4 is a side view of the compact collapsible stroller of the present disclosure, in which the child seat frame is in the seat mode;

FIG. 4A is a side view of the compact collapsible stroller of the present disclosure, in which the child seat frame is in the cradle mode;

FIG. 5 is a partial view of different modes of the child seat frame of the compact collapsible stroller of the present disclosure;

FIG. 6 is a partial view of the child seat frame of the compact collapsible stroller in the seat mode of the present disclosure;

FIG. 7 is a perspective exploded view of some parts of the child seat frame of the compact collapsible stroller of the present disclosure;

FIG. 8 is a partial view of the child seat frame of the compact collapsible stroller in different states of the present disclosure;

FIG. 9 is a side view of the child seat frame of the compact collapsible stroller in an unfolded and folded state of the present disclosure;

FIG. 10 is a side view of the main stroller frame of the compact collapsible stroller of the present disclosure;

FIG. 11 is a partial view of the main stroller frame of the compact collapsible stroller of the present disclosure, in which one side of the internal structure is exposed;

FIG. 11A is a partial view of the main stroller frame of the compact collapsible stroller of the present disclosure, in which the other side of the internal structure is exposed;

FIG. 12 is a view of the main stroller frame of the compact collapsible stroller in a folded state of the present disclosure;

FIG. 13 is a schematic view showing a partial internal structure of the main stroller frame of the compact collapsible stroller of the present disclosure;

FIG. 14 is a partial schematic view showing the main stroller frame of the compact collapsible stroller of the present disclosure, in which a part of the area is enlarged to show its structure more clearly;

FIG. 15 is a partial view of the main stroller frame of the compact collapsible stroller of the present disclosure, in which one side of the internal structure is exposed;

FIG. 16 is a partial side view of the compact collapsible stroller of the present disclosure;

FIG. 16A is a side view of the compact collapsible stroller in a folded state of the present disclosure;

FIG. 17 is a partial side view of the compact collapsible stroller of the present disclosure;

FIG. 17A is a perspective view of the compact collapsible stroller in a folded state of the present disclosure;

FIG. 18 is a perspective view of the child seat frame of the compact collapsible stroller of the present disclosure;

FIG. 19 is a side view of the child seat frame of the compact collapsible stroller of the present disclosure;

FIG. 20 is a side view of some parts of the child seat frame of the compact collapsible stroller of the present disclosure;

FIG. 21 is a perspective view of some parts of the child seat frame of the compact collapsible stroller of the present disclosure;

FIG. 22 is a perspective view of some parts of the child seat frame of the compact collapsible stroller of the present disclosure;

FIG. 23 is a perspective view of some parts of the child seat frame of the compact collapsible stroller of the present disclosure;

FIG. 24 is a side view of the child seat frame of the compact collapsible stroller of the present disclosure.

### LIST OF REFERENCE SIGNS

compact collapsible stroller 1
main stroller frame 10
handle portion 110
handle portion plate 111
spring biased plunger 112
upper handle portion 113
handle portion hub 114
circular barrel 1141
lower handle portion 115
pivot point 1151
upper link 116
lower link 117
rear leg portion 120
rear leg portion plate 121
locking pin 1211
pivot point 122
front leg portion 130
front leg portion plate 131
central frame hub 140
frame latch 150
extended latching surface 151
link 160
adapter portion 170
rear wheels 180
carrying basket 190
child seat frame 20
upper frame 210
upper seat frame hub 211
ramped surface 2111
spiral control surface 2112
upper frame plunger 212
fold handle 213
lower frame 220
lower seat frame hub 221
lower frame plunger 222
lower frame plunger control post 2221
recline handle 223
child tray 230
child tray hub 231
seat mount 240
latch pin assembly 250
ramped surface 251

### DETAILED DESCRIPTION OF THE INVENTION

In order to further illustrate the principle and structure of the present disclosure, the preferred embodiments of the present disclosure will be described in detail with reference to the accompanying drawings. However, the embodiments are only provided for illustration and explanation and cannot be used to limit the scope of patent protection of the present disclosure.

The terms used in the present disclosure are only for the purpose of describing specific embodiments and are not intended to limit the present disclosure. The singular forms of “a”, “said” and “the” used in the present disclosure and the appended claims are also intended to include plural forms, unless the context clearly indicates other meanings. It should also be understood that the term “and/or” used herein refers to and includes any or all possible combinations of one or more associated listed items.

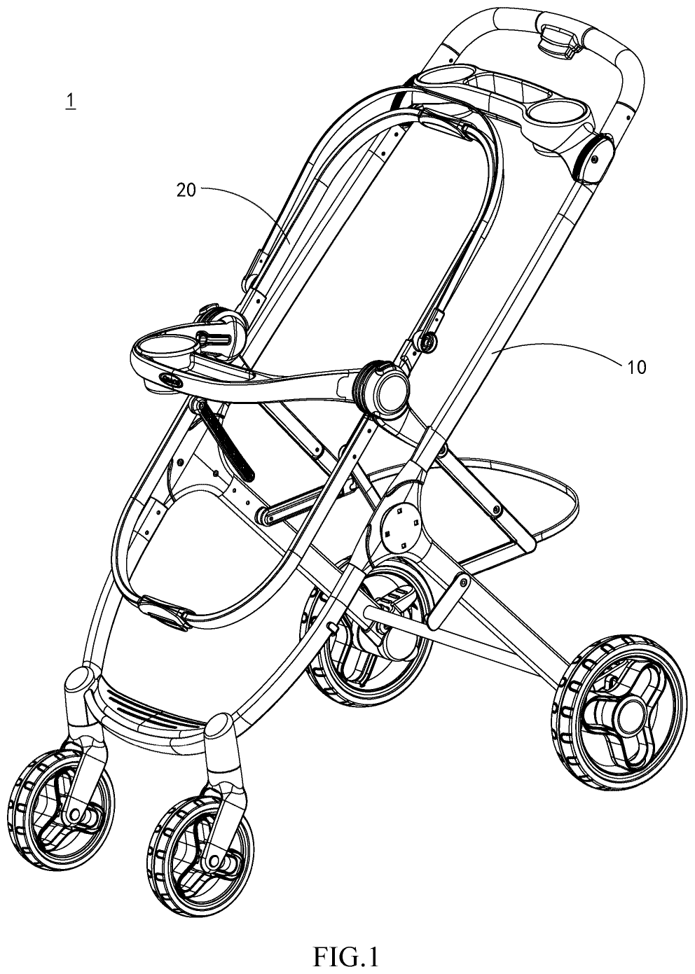

The compact collapsible stroller (hereinafter referred to as “stroller”) 1 of the present disclosure includes a collapsible main stroller frame 10, which can accommodate child seat frames 20 of various configurations (as shown in FIG. 1).

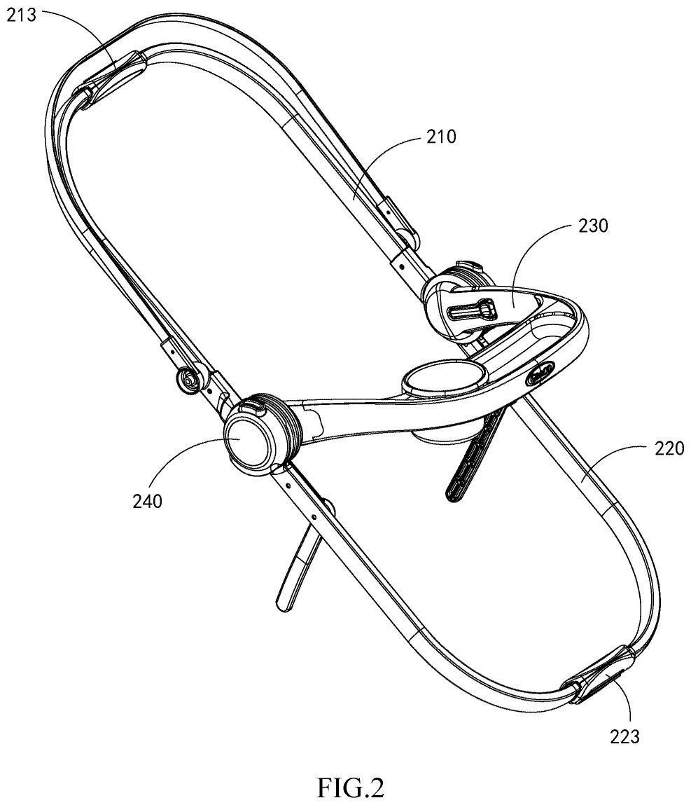

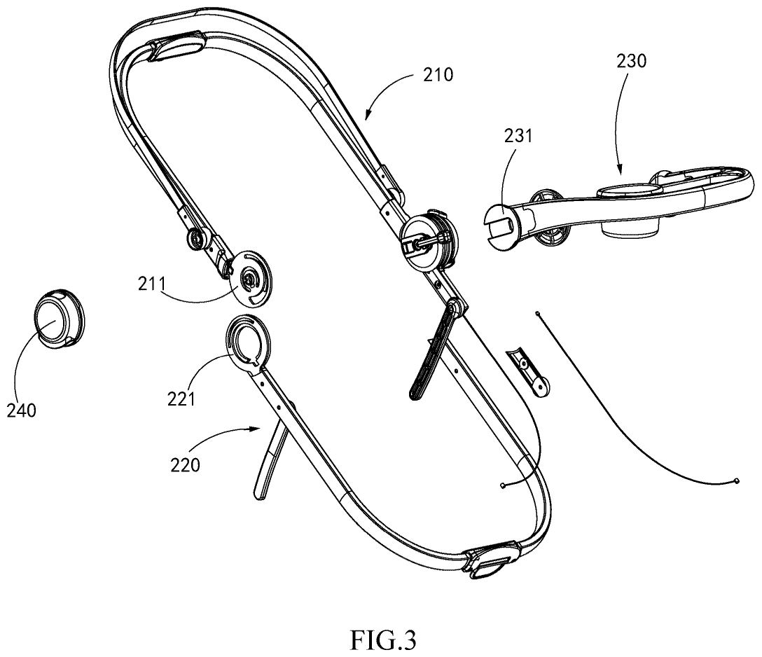

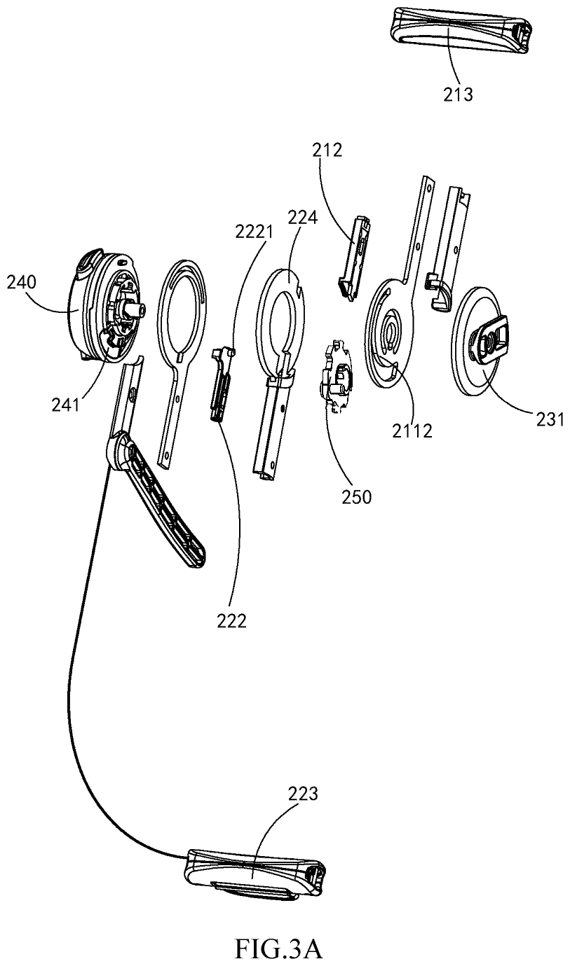

One configuration of the child seat frame 20 may include an upper frame 210, a lower frame 220, a child tray 230, and a seat mount 240 (as shown in FIG. 2). The upper frame 210 and the lower frame 220 are pivotally connected to the seat mount 240 through an upper seat frame hub 211 and a lower seat frame hub 221. Likewise, as shown in FIGS. 3 and 3A, the child tray 230 is pivotally connected to the seat hub (seat mount) 240 through a child tray hub 231.

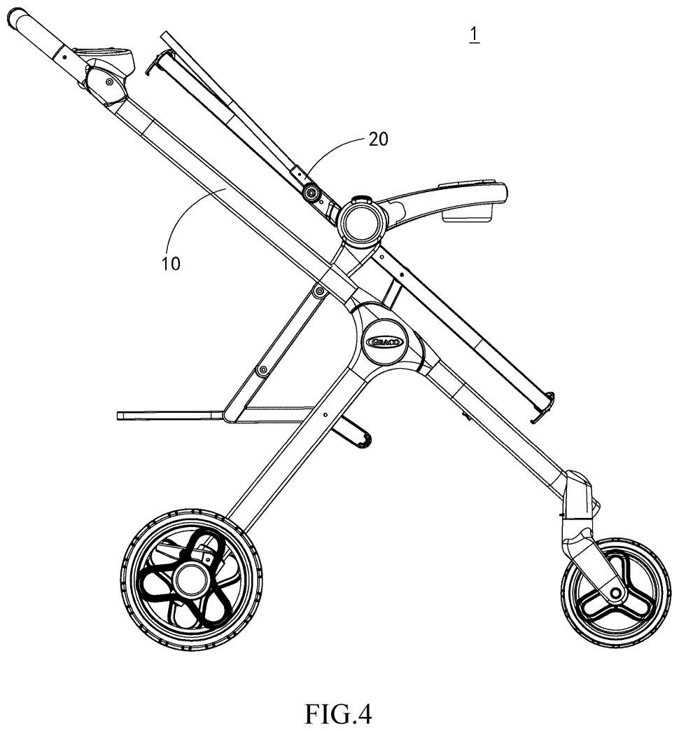

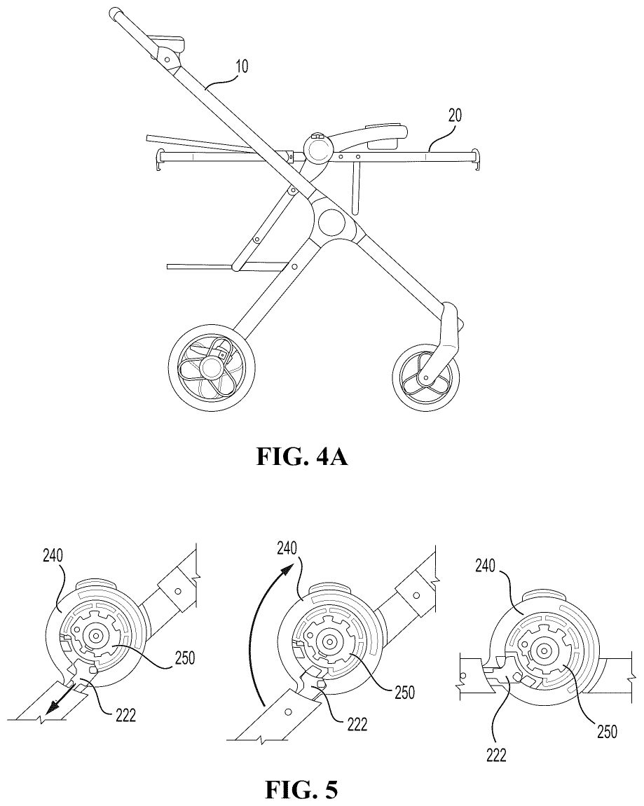

Referring to FIGS. 4 and 4A, the child seat frame 20 may have a seat mode and a cradle mode. One configuration for attaching the child seat frame 20 to the main stroller frame 10 is in a forward sitting position, which is the seat mode. In the seat mode, the upper frame 210 may extend upward from the seat mount 240, specifically, obliquely extending backward and upward, and the lower frame 220 may extend downward from the seat mount 240, specifically, obliquely extending forward and downward. At this time, the upper frame 210 and the lower frame 220 are formed in a linear shape passing through the seat mount 240. In the cradle mode, the upper frame 210 and the lower frame 220 extend horizontally from the seat mount 240 to both sides thereof. The child seat frame 20 can be converted from the position shown in FIG. 4 to a position where the cradle is lying down.

Referring to FIG. 5, in order to convert the child seat frame 20 from the seat mode to the cradle position (i.e., cradle mode), the user may manipulate the recline handle 223, which uses a cable to retract the spring-loaded lower frame plunger 222 from a position engaging with the seat mount 240. This allows the entire child seat frame 20 to rotate to a horizontal position relative to the seat mount 240, and re-engages the spring-loaded lower frame plunger 222 with the seat mount 240 to lock the child seat frame 20 in this position.

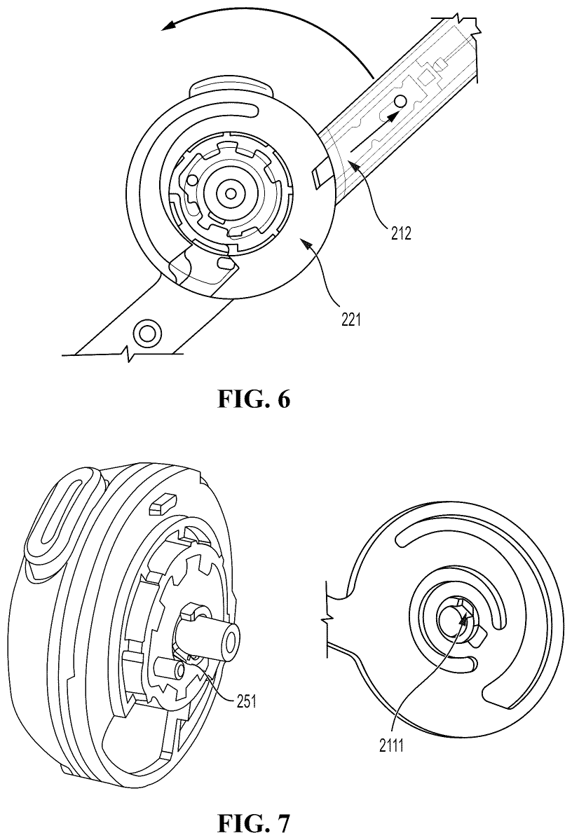

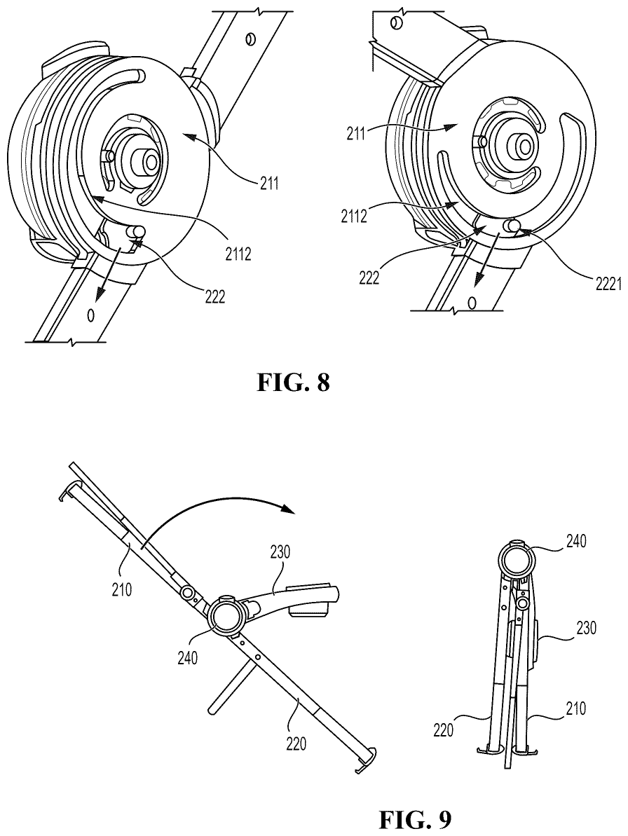

Referring to FIG. 6, in addition to the reclining handle 223, the child seat frame 20 also includes a fold handle 213 for folding the child seat frame 20 as a part of the folding of the stroller. The fold handle 213 retracts the spring-biased upper frame plunger 212 from its engagement position with the lower seat frame hub 221. The upper frame (i.e., upper seat frame) 210 can now rotate around the seat mount 240 relative to the lower frame (i.e., lower seat frame) 220. Referring to FIG. 7, when the upper frame 220 rotates, a ramped surface 2111 in the upper seat frame hub 211 acts on a ramped surface 251 on the latch pin assembly 250 to press the latch pin assembly 250 into the seat mount 240, and separate the latch pin assembly 250 from the child tray hub 231, thereby releasing the child tray 230 to be able to pivot freely around the seat mount 240. In addition, referring to FIG. 8, a spiral control surface 2112 located in the upper seat frame hub 211 disengages the two lower seat frame hubs 221 from the seat mount 240 because it acts on a lower frame plunger control post 2221. This allows the lower frame 220 to rotate around the seat mount 240 to a relatively vertical (upright) position with respect to the seat mount 240. The spiral control surface 2112 is formed to gradually move away from the center of the upper seat frame hub 211 from one side to the other, so that when the upper seat frame hub 211 rotates relative to the seat mount 240, the spiral control surface 2112 may abut against and push the lower frame plunger control post 2221 to move away from the seat mount 240. Referring to FIG. 9, this operation causes the upper frame 210, the lower frame 220 and the child tray 230 to fall parallel to one another and relatively vertical (upright) to the seat mount 240.

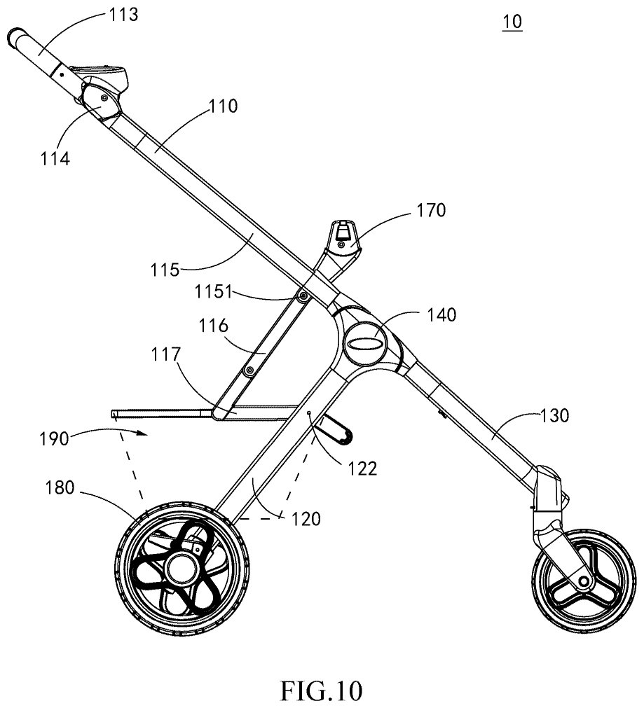

Referring to FIG. 10, the stroller main frame 10 may include a handle portion 110, a rear leg portion 120 and a front leg portion 130. Each part of the stroller main frame 10 is pivotally connected to a central frame hub 140. An lower end of the rear leg portion 120 has rear wheels 180. An lower end of the front leg portion 130 has front wheels.

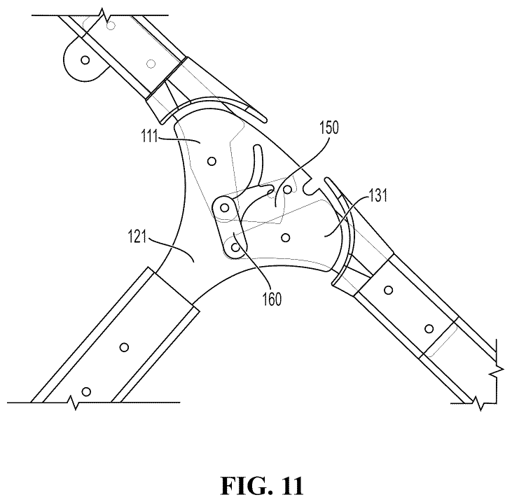

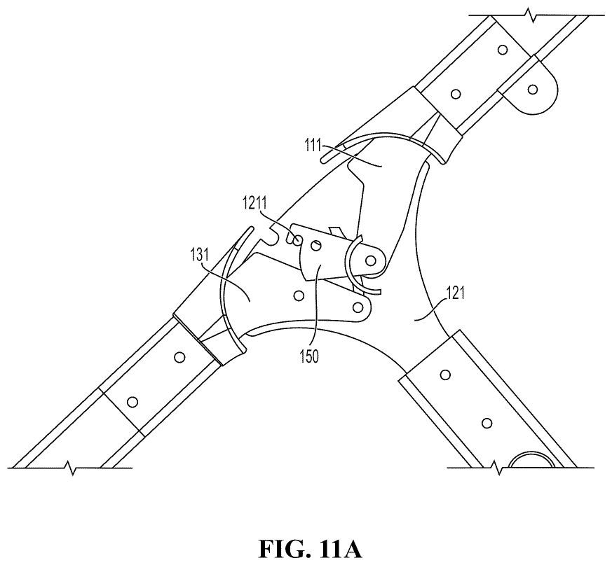

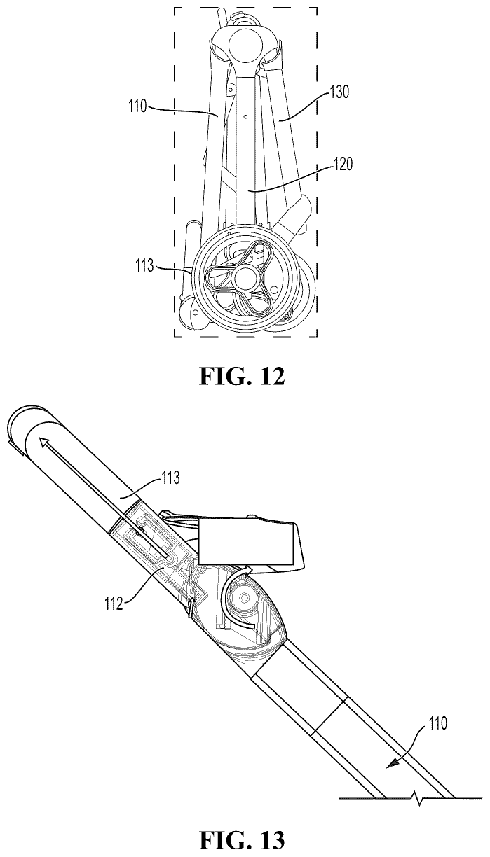

Referring to FIGS. 11 and 11A, a frame latch 150 pivotally connected to a handle part plate 111 engages with a locking pin 1211 on the rear leg part plate 121 such that the stroller 1 is locked in the opened position. When the frame latch 150 is rotated so that the latch surface passes through the lock pin 1211 and is disengaged from the lock pin 1211, the handle section plate 111 is allowed to rotate, and a front leg section plate 131 is pulled by a link 160 to the folded position. Referring to FIG. 12, the handle portion 110, the rear leg portion 120, and the front leg portion 130 are folded almost parallel to one another to obtain a compact folded size for easy transportation or storage of the main stroller frame 10 when the stroller is not in use. Referring to FIG. 13, the upper half of the handle portion 110 is locked by a spring biased plunger 112 and thus cannot be rotated, the spring biased plunger 112 is pulled to an unlocked state by a cable anchored in a main folding release housing. In this way, the upper handle portion 113 and the parent bracket (the part extending horizontally from the upper handle portion 113 as shown in FIG. 10) can be rotated in the folding process to obtain a more compact folding size. Referring to FIG. 12, the stroller 1 has a folding boundary (as shown by the dotted block in FIG. 12) in the folding process. When the stroller 1 is transformed between the unfolded state and the folded state, none of the parts can exceed beyond the folding boundary.

Referring to FIG. 13, the upper handle portion 113 is pivotally fixed to the handle portion hub 114. The spring biased plunger 112 is engaged with the handle portion hub 114 so that the upper handle portion 113 cannot pivot relative to the handle portion hub 114. The spring biased plunger 112 can be actuated via a cable to disengage from the handle portion hub 114 so that the upper handle portion 113 can pivot relative to the handle portion hub 114.

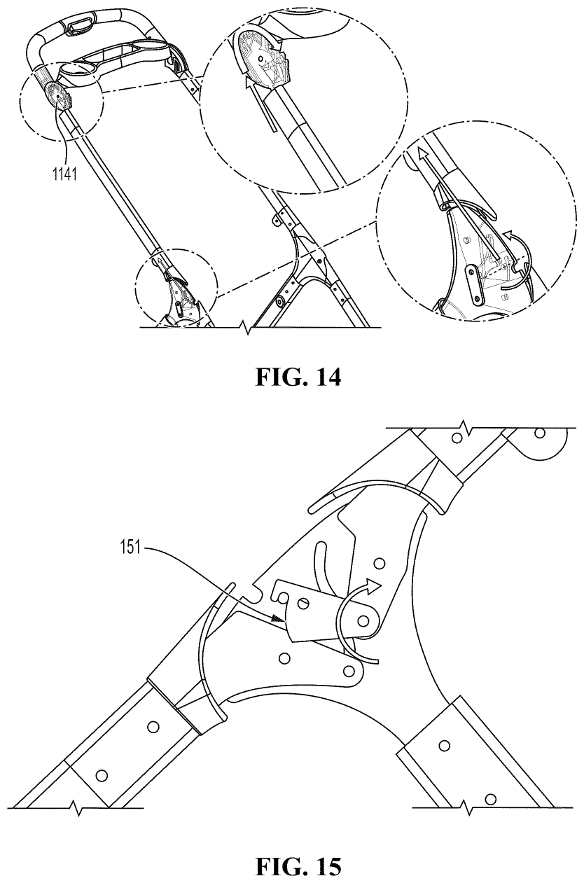

Referring to FIG. 14, the cable anchored on a circular barrel 1141 in the handle portion hub 114 and attached to the frame latch 150 rotates with the upper handle portion 113, to actuate the frame latch 150 (an arrow in FIG. 15 shows a direction in which the frame latch 150 is actuated) and pivot it past the locking pin, and thus fold the handle portion 110 toward the closed position. Time for folding is controlled by an extended latch surface 151 of the frame latch 150. The extended latch surface 151 allows the frame latch 150 to engage with the locking pin 1211 until the upper handle portion 113 has rotated by a larger distance from its original position. When the extended latch surface 151 is disengaged from the locking pin 1211, the handle portion 110 may be folded toward the closed position. This results in a more natural folding movement while preventing the main stroller frame 10 from being accidentally folded (as shown in FIG. 15). When the upper handle portion 113 rotates toward the opened position, an anchor end of the cable rotates backward (counterclockwisely as shown in FIG. 13) along with the upper handle portion 113, and the length from the cable to the frame latch 150 increases, which allows the frame latch 150 to re-engage with the locking pin 1211.

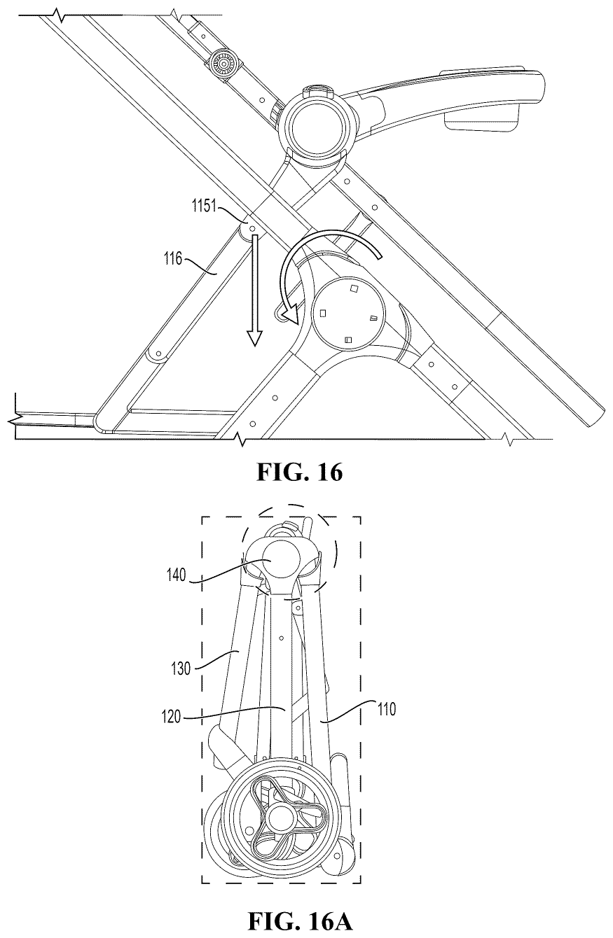

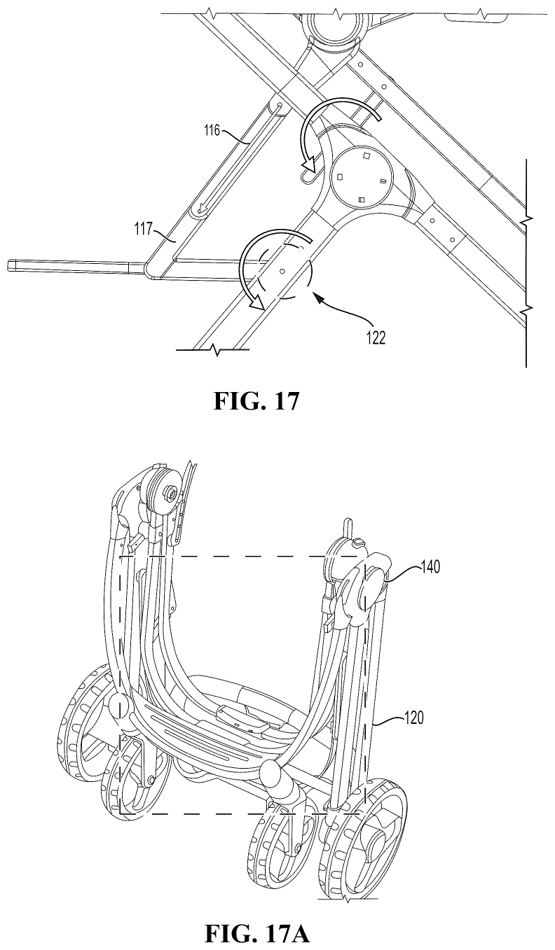

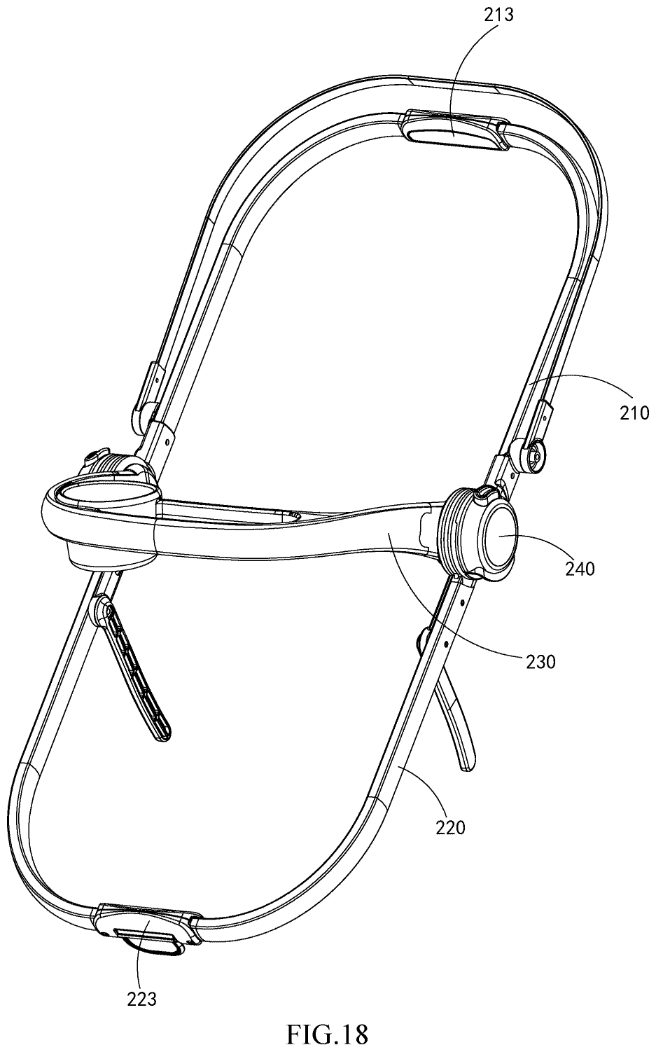

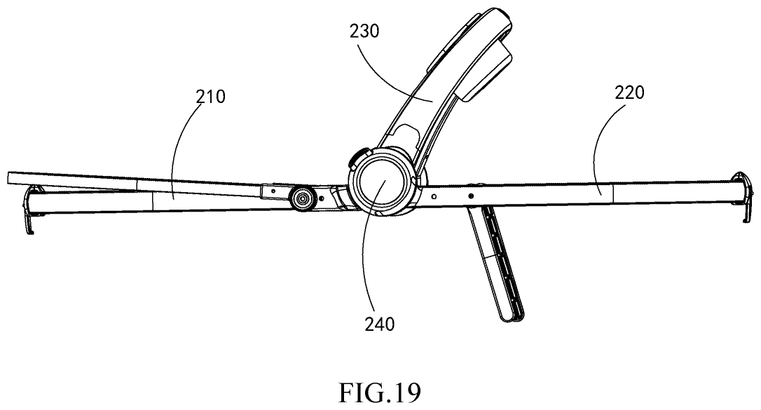

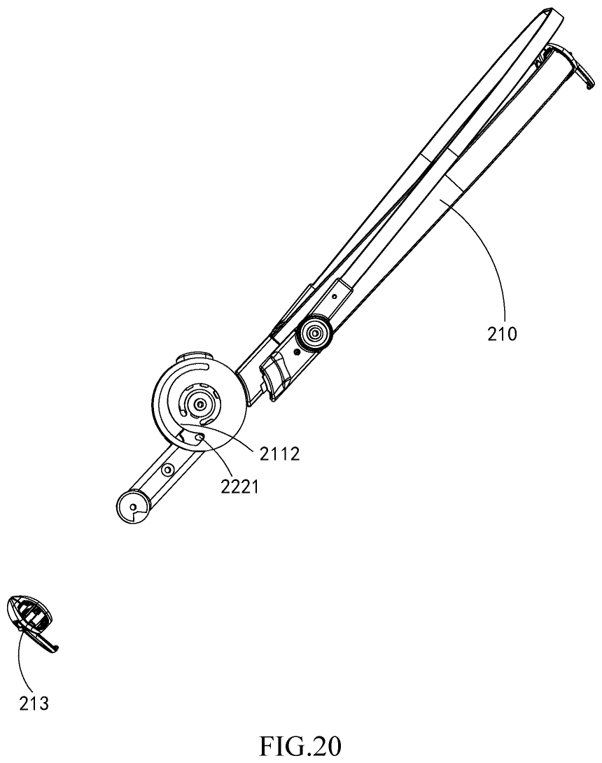

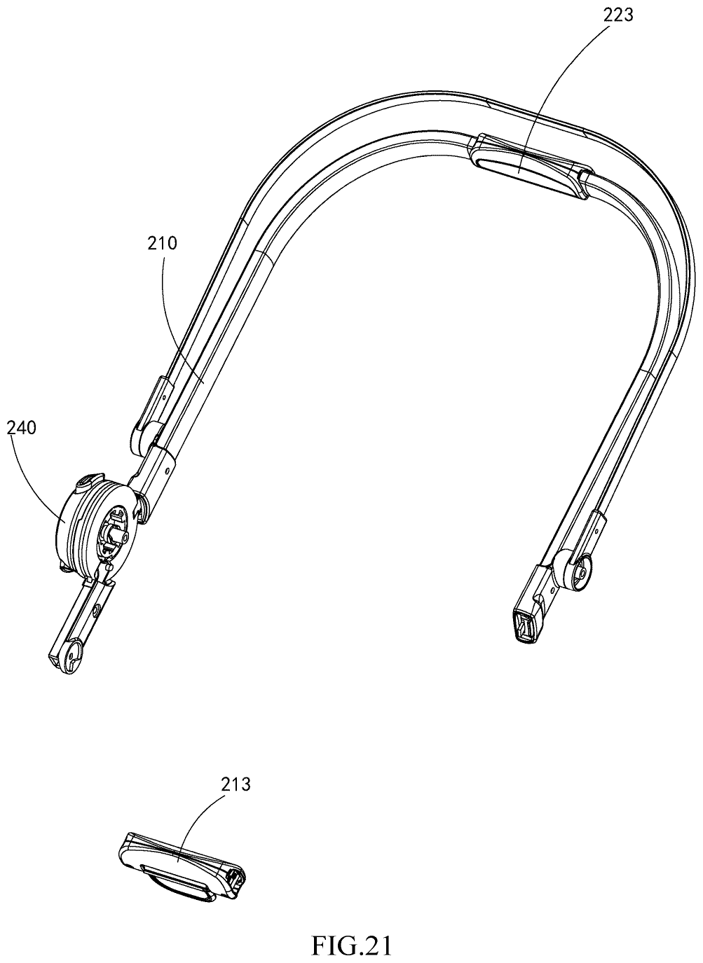

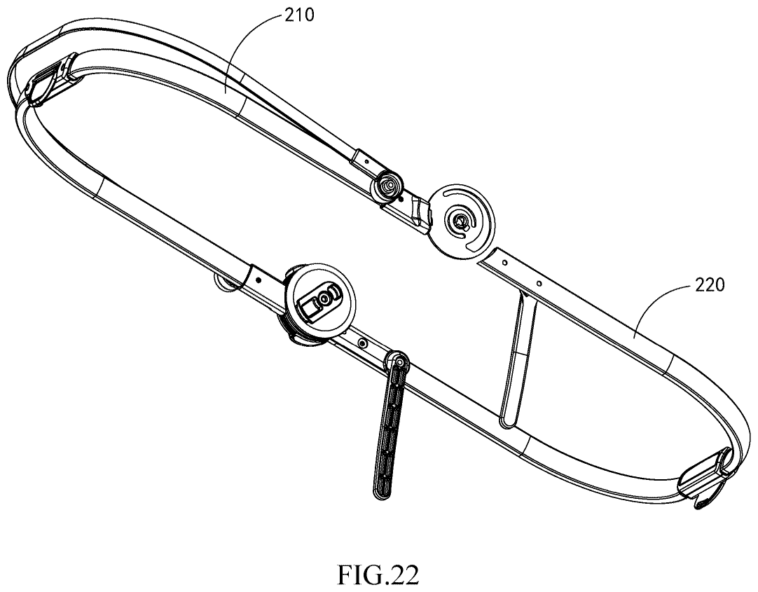

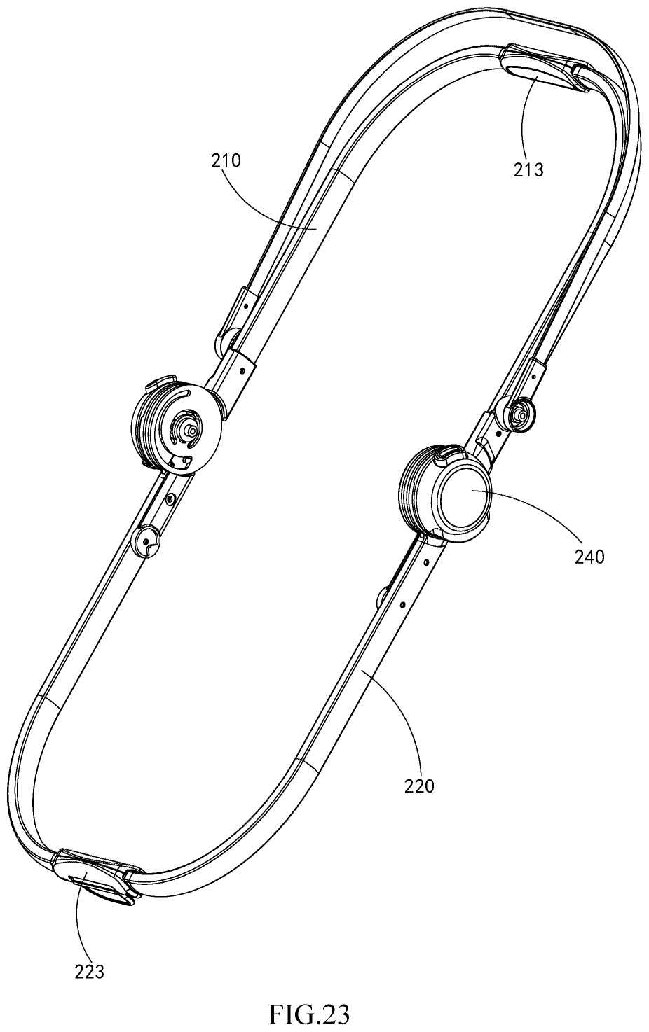

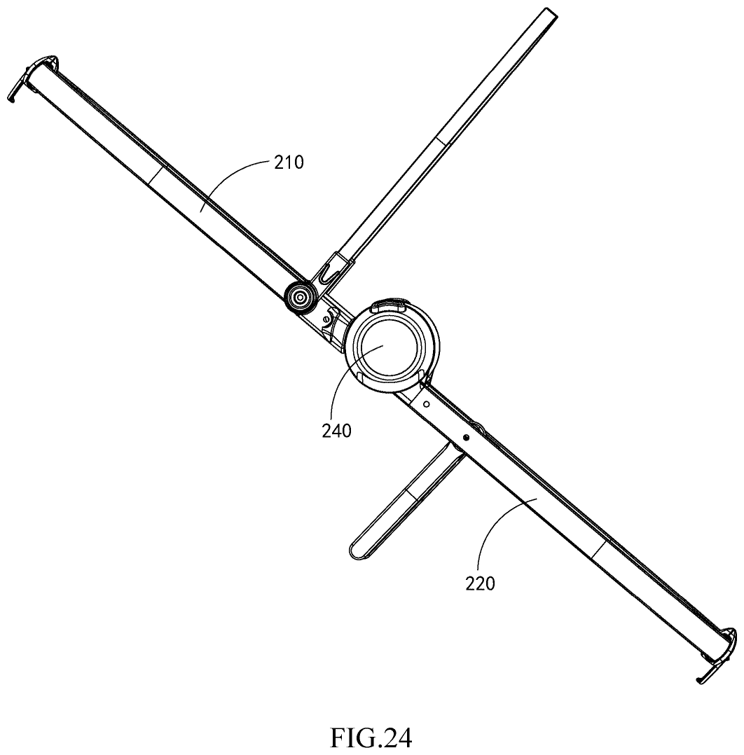

Referring to FIGS. 16 and 16A, the rotation of the lower handle portion 115 also drives a series of couplings between the seat mount 240 and the stroller basket for carrying the baby. An upper link 116 is directly attached to the seat frame hub (seat mount) 240 and is connected to the handle portion 110 at a pivot point 1151. An upper end of the upper link 116 is formed with an adapter portion 170 (see FIG. 10). Due to the downward folding movement of the handle portion 110, the upper link 116 is driven downward and the child seat hub (seat mount) 240 is pulled within a predetermined folding boundary. Referring to FIGS. 17 and 17A, a basket frame is attached between a lower link 117 and a pivot point on the rear leg portion 120. A carrying basket 190 may be provided below a basket frame (a left part of the lower link 117 as shown in FIG. 10). During the folding of the main stroller frame 10, only the carrying basket 190 is linked to the main stroller frame 10 to be folded, while the adapter portion 170 is not linked. Through the downward folding movement (pivoting movement) of the handle portion 110, the upper link 116 drives the lower link 117 in a downward movement, and further drives the basket frame downward and rotates it behind the rear leg portion 120. This allows the basket frame to be installed within the folding boundary while maximizing its size so as to achieve maximum storage capacity.

When the stroller 1 is transformed from the unfolded state (shown in FIGS. 16 and 17) to the folded state (shown in FIGS. 16A and 17A), the seat mount 240 gradually approaches the central frame hub 140, and finally overlaps or at least substantially overlaps in a transverse direction (perpendicular to the paper surface of FIG. 16A). At this time, the handle portion 110, the rear leg portion 120, and the front leg portion 130 vertically extend substantially downward from the central frame hub 140, and the upper frame 210, the lower frame 220, and the child tray 230 vertically extend substantially downward from the seat mount 240, so that the stroller 1 in the folded state occupies the minimum space.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

Although the present disclosure has been described with reference to the exemplary embodiments, the terms used are illustrative and exemplary rather than restrictive. Since the present disclosure can be implemented in various forms without departing from the spirit and essence of the present disclosure, it should be understood that the foregoing embodiments are not limited to any of the foregoing details, but should be interpreted in the broadest sense within the scope defined by the claims. Therefore, all changes falling within the scope of the claims or their equivalents shall be covered by the claims.

1-10. (canceled)

11. A collapsible stroller comprising:
a stroller frame including a handle portion comprising a lower handle portion and an upper handle portion rotatably coupled to one another and a rear leg portion including rear wheels, a front leg portion including front wheels, wherein the lower handle portion, the rear leg portion and the front leg portion are pivotally coupled to one another so that the stroller frame is foldable from an in-use configuration in which the lower handle portion, the rear leg portion and the front leg portion are locked against rotation relative to one another and a folding configuration in which the lower handle portion, the rear leg portion and the front leg portion are unlocked for rotation relative to one another into a collapsed configuration in which the stroller frame defines a folding boundary;
a basket portion pivotally connected to the rear leg portion; and
an adapter portion including a seat mount releasably connectable to a seat frame, the adapter portion being pivotally connected to the lower handle portion and pivotally connected to the basket portion, wherein the pivotal connection between the adapter portion and the basket portion is configured so that, folding of the stroller frame, pivots the handle lower portion relative to the rear leg portion so that the adapter portion drives the basket portion downward and rotates the basket portion relative to the rear leg portion within the folding boundary of the stroller frame.

12. The stroller of claim 11, wherein the stroller frame is configured so that, when folded from the in-use position to the collapsed configuration, the adapter portion approaches the rear wheels, and wherein the lower handle portion is coupled to the upper handle portion so that, rotation of the upper handle portion relative to the lower handle portion disengages the lower handle portion from the rear leg portion and the front leg portion so that the lower handle portion is rotated so that the seat mount approaches a pivot point at which the basket portion is pivotally coupled to the rear leg portion.

13. The stroller of claim 11, wherein the lower handle portion is coupled to the rear leg portion via a handle latch that releasably engages a locking member of the rear leg portion, the handle latch being rotatable between a latched position in which the lower handle portion is locked against rotation relative to the rear leg portion and an unlatched position in which the lower handle portion is rotatable relative to the rear leg portion.

14. The stroller of claim 13, wherein the handle latch includes a curved locking member engaging surface where a length of the surface is selected to lock the lower handle portion against rotation relative to the rear leg portion until the handle latch has been rotated through a desired angular range.

15. The stroller of claim 14, wherein the handle latch is rotatably coupled to a first end of the lower handle portion adjacent to the rear leg portion and the handle latch is coupled to the upper handle portion via a cable so that, rotation of the upper handle portion relative to the lower handle portion rotates the handle latch from the latched position to the unlatched position.

16. The stroller of claim 11, wherein the folding boundary is defined by the handle portion and the front and rear leg portions and wherein, in the collapsed configuration, the entire stroller is within the folding boundary.

17. The stroller of claim 16, wherein the lower handle portion, the rear leg portion and the front leg portion are pivotally connected to one another at a central frame hub and wherein, in the collapsed configuration, the central frame hub and the seat mount overlap in a lateral direction.

18. The stroller of claim 17, wherein, in the collapsed configuration, each of the handle portion, the rear leg portion, and the front leg portion extends substantially vertically downward from the central frame hub.

19. The stroller of claim 18, wherein the seat frame includes an upper frame and a lower frame pivotally connected to one another for rotation between an open configuration and a folded configuration and wherein the seat frame is pivotal relative to the adapter portion so that the entire seat frame may be rotated relative to the stroller frame between a recline position and a seated position.

20. The stroller of claim 19, wherein, when the seat frame is connected to the adapter portion, folding of the stroller frame to the collapsed configuration, folding of the seat frame to the folded configuration brings the seat frame within the folding boundary of the stroller frame.

21. The stroller of claim 20, wherein, in the folded configuration, each of the upper frame and the lower frame extends substantially vertically downward from the seat mount.

22. The stroller of claim 11, wherein the basket portion extends rearward from the rear leg portion, the basket portion rotating and simultaneously moving close to the rear leg portion when the stroller is folded to the collapsed configuration.

23. The stroller of claim 22, wherein the stroller frame includes an upper link attached to the adapter portion and pivotally connected to the lower handle portion and a lower link connected to the basket portion and pivotally connected to the rear leg portion and the upper link.

24. The stroller of claim 23, wherein, when folding the stroller frame from the in-use configuration to the collapsed configuration, a downward pivoting movement of the lower handle portion moves the upper link to drive the lower link downward so that the basket portion rotates within the folding boundary of the stroller frame.

25. The stroller of claim 19, wherein, in the seated position, the upper frame extends obliquely upward and rearward from the lower frame.

26. The stroller of claim 25, further comprising a reclining handle coupled to the seat frame via a first actuation cable so that actuation of the reclining handle unlocks the upper frame and the lower frame to rotate as a unit between the seated and recline positions.

27. The stroller of claim 26, wherein the reclining handle is mounted on the seat frame.

28. The stroller of claim 21, further comprising a fold handle coupled to the seat frame via a second actuation cable so that actuation of the fold handle unlocks at least one of the upper frame and the lower frame for rotation relative to the other of the upper frame and the lower frame.

29. The stroller of claim 28, wherein the seat frame further comprises a tray coupled to one of the upper and lower frames via a tray hub, the tray hub being configured to unlock the tray upon actuation of the fold handle so that the tray can rotate relative to at least one of the upper frame and the lower frame.
